(19) United States
(12) Patent Application Publication
(10) Pub. No.: US 2012/0273479 A1
(43) Pub. Date: Nov. 1, 2012

(54) MULTIPURPOSE HEATING PAD

(76) Inventor: Soo Ho Kim, Anyang (KR)

(21) Appl. No.: 13/512,993

(22) PCT Filed: Oct. 12, 2010
(86) PCT No.: PCT/KR2010/006985

§ 371 Date: Jul. 3, 2012

(30) Foreign Application Priority Data
Dec. 1, 2009 (KR) 10-2009-0118049

(51) Int. Cl. H05B 1/02

(52) U.S. Cl. 219/494

(57) ABSTRACT

Provided is a multipurpose heating pad that can be placed atop a chair, mat, or other surface and used or placed below the same and used, and is formed as a standalone heating pad. The pad includes a heating element controlled and operated by a controller that is selectively connectable to an AC or DC power supply, and one of various types of cover materials in which the heating element is entirely enclosed. As the pad can be selectively used with an AC power supply, DC power supply, or a rechargeable power supply as required, it can be effectively used indoors, outdoors, and in moving vehicles. Further, when the inner heating element is formed in sections and the sections are sequentially operated, a significant amount of power is saved due to the heating effects of latent heat, so that the power consumption is reduced.

### TECHNICAL FIELD

The present invention relates to a multipurpose heating pad which is placed on the surface of a chair or a mat when it is used, or placed under a chair or a mat when it is used, and more particularly, to a multipurpose heating pad structured such that a heating element connected with a controller which is selectively connectable to a direct current (DC) power supply or an alternating current (AC) power supply is provided inside one of various types of cover members. The heating pad is very cost effective because the heating pad can be manufactured in various sizes to suit the purpose and thus can be placed atop or under various objects or directly fixed to the various objects when it is used. Furthermore since the heating pad is formed in sections and the sections generate heat in succession, power consumption is reduced and the power saving effect is large.

### BACKGROUND ART

Recently, various sheet-type heating elements or flexible heating elements have been developed, resulting in the trend to commercialize various heating products using such heating elements.

Heating products help a user to effectively keep his body temperature because of a heat generation operation of a heating element to which power is supplied during the winter season or when the user works, studies, is relaxing, or does everyday living activities under a condition of low temperature.

Representative examples of such a heating product include a heating vest, a heating sheet, a heating cushion, and a heating mat. The known heating products are structured such that a heating element and an object such as a vest or a cushion are separately prepared and the heating element is inserted and fitted inside the object. Accordingly, the heating element is hidden inside the object not to be viewed from the outside so that it looks like just an ordinary vest or cushion. The heating element is an embedded heating element that carries out heating and warming actions and that generates heat when power is supplied.

However, a problem with such a heating element is that an object must be used in combination with the heating element. That is, the heating element cannot be used as a standalone product but has to be embedded in or fitted in a vest, sheet, cushion or the like to be used.

For such a reason, the heating products in which the heating element is embedded remain unused during most of the year except for the winter season. Therefore, the heating products are not cost effective. Furthermore the heating products are expensive because the heating element and the object to be combined with the heating element are purchased together. Further, most heating products in which the heating element is embedded are designed to be used only in the winter season. Accordingly, such a product becomes unnecessary in the summer season or hot weather when heating products are unnecessary. Furthermore, when the user wants to use the same kind of object originally combined with the heating product by itself, the user has to purchase a new one for the summer season because the object combined with the heating product is only for the winter season. Accordingly, the conventional heating products are not cost effective.

Furthermore, in the case of objects such as strollers, tents, or sleeping bags which are usually carried to be used and are used in a state in which it is difficult to obtain power, the heating element is less likely to be combined with such an object. Even if the heating element is combined with such an object, since the power consumption is very large, the heating period is very short due to the limited capacity of a rechargeable battery.

### DISCLOSURE

### Technical Problem

The present invention can reasonably address the above problems, and is intended to provide a multipurpose heating pad formed as a standalone heating pad in which a heating element controlled and operated by a controller that is selectively connectable to an AC power supply or a DC power supply is entirely enclosed, wherein by performing a simple adjustment of the size thereof, the multipurpose heating pad can be used while being placed atop or under any one of various objects, or while being directly attached to an object.

### Technical Solution

In order to achieve the object of the present invention, according to one aspect of the invention, there is provided a multipurpose heating pad including a heating element connected to a controller, in which the heating element is operated to generate heat according to control of the power supply by the controller, and the heating element is entirely enclosed by an additional cover member so that a standalone heating pad is formed, wherein when power is supplied to the controller, the heating element is generates heat for the time and temperature set by the controller, and the heat from the heating element is transferred to the surface of the heating pad through the cover member.

### Advantageous Effects

The multipurpose heating pad according to the present invention can be used while placed atop or under any one of various objects that require heating, or can be directly attached to an object and used, such that by performing a simple adjustment of the size thereof, there are no restrictions with regard to the type of object with which the pad can be used, thus making the pad highly useful. Also, as the pad can be selectively used with an AC power supply, DC power supply, or a rechargeable power supply as required, it can be effectively used indoors, outdoors, and in moving vehicles. Further, when the heating element is formed in sections and the sections are sequentially operated, a significant amount of power is saved due to the heating effects of latent heat, thereby enabling a reduction in the power consumed, so that a highly economical heating pad with low power consumption and a greatly extended operating time in the case of a rechargeable power supply is provided.

### DESCRIPTION OF DRAWINGS

FIG. 1 is a schematic diagram illustrating an outline of a heating pad according to the invention.

FIG. 2 is a diagram illustrating connection of power lines to supply power to a heating element in the heating pad according to the invention.

FIG. 3 is a sectional view illustrating the heating pad according to the invention.

FIG. 4 is an enlarged sectional view illustrating an embodiment of a cover member of the heating pad according to the invention.

FIG. 5 is an enlarged sectional view illustrating another embodiment of the cover member of the heating pad according to the invention.

FIG. 6 is an enlarged sectional view illustrating a further embodiment of the cover member of the heating pad according to the invention.

FIG. 7 is an enlarged sectional view illustrating yet a further embodiment of the cover member of the heating pad according to the invention.

FIG. 8 is an enlarged sectional view illustrating yet a further embodiment of the cover member of the heating pad according to the invention.

FIG. 9 is a diagram illustrating a heating element according to another embodiment of the invention.

FIG. 10 is a diagram illustrating a power line connection that supplies power to the heating element.

FIG. 11 is a block diagram illustrating a controller of the heating pad according to the invention.

FIG. 12 is a diagram illustrating a power supply unit of the heating pad according to the invention.

FIG. 13 is a diagram illustrating another embodiment of the power supply unit of the heating pad according to the present invention.

FIG. 14 is a diagram illustrating a further embodiment of the power supply unit of the heating pad according to the present invention.

### EXPLANATION OF REFERENCE LETTERS

10: HEATING ELEMENT

11, 11′: MAIN POWER LINE

12, 12′: AUXILIARY POWER LINE

20: CONTROLLER

21: POWER SUPPLY UNIT

22: TIME ADJUSTING UNIT

23: TEMPERATURE ADJUSTING UNIT

24: CENTRAL PROCESSING UNIT

25: DISPLAY UNIT

26: AC CORD

27: AC ADAPTER

28: CHARGEABLE UNIT

30: COVER MEMBER

31, 31′: NEOPRENE SHEET

32: ADHESION FILM

33: HEAT-INSULATING SHEET

34: HEAT STORAGE AND TRANSFER SHEET

35: URETHANE FOAM

36: ADHESION LAYER

37, 37′: POLYURETHANE SHEET

40: HEATING PAD

### BEST MODE

### Mode for Invention

Unless otherwise defined, all terms used in this specification and claims should be contextually interpreted in light of the concept of the present invention and are not to be interpreted using the ideal or expressively formal meanings defined in a generally used dictionary per the principle that inventors can define specific terms to most properly describe their inventions.

Hereinafter, a preferred embodiment of the present invention will be described in detail with reference to the accompanying drawings.

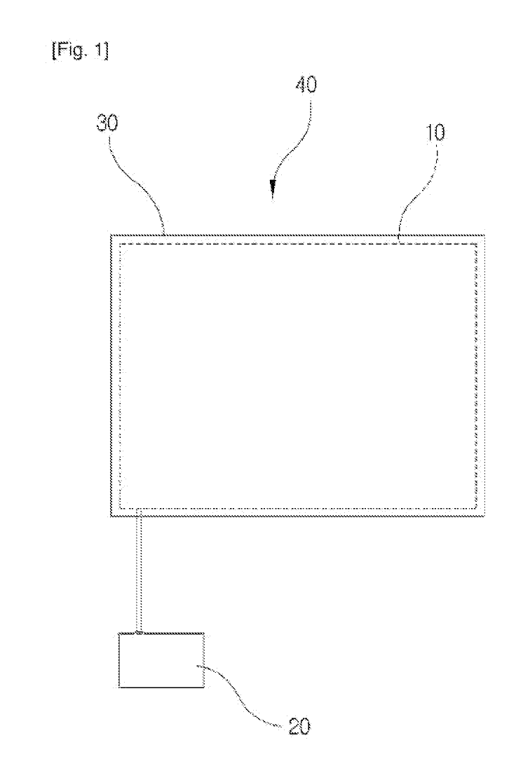

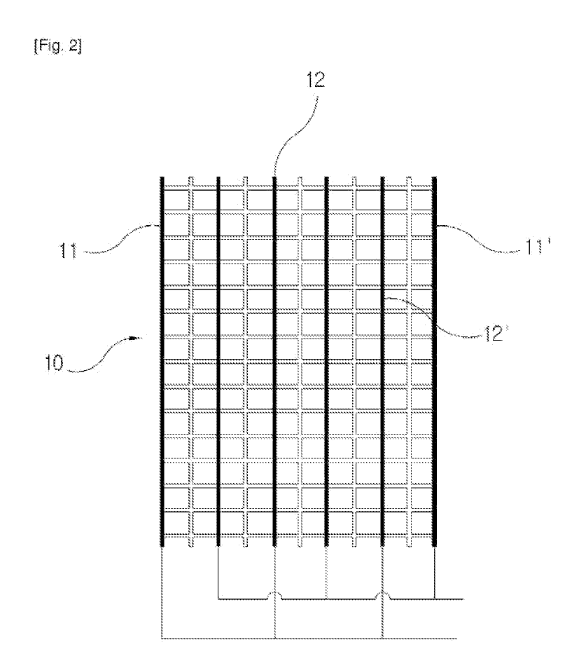

FIG. 1 is a schematic diagram illustrating an outline of a heating pad according to the present invention.

As illustrated, a heating pad 40 according to the present invention is structured such that a heating element 10 connected to a controller 20 is enclosed by a cover member 30. The heating element 10 is hidden inside the cover member 30 so that only the cover member 30 and the controller 20 can be seen from outside.

Since the heating element 10 of the heating pad 40 is protected by the cover member 30, waterproofness, durability, heat-insulation, and chemical resistance of the heating pad 49 depend on the type of the cover member 30. When power is supplied from the controller 20 to the heating element 10, the heating element 10 is heated first, then the heat from the heating element 10 is transferred through the cover member 30, and finally the heating effect of the entire heating pad 40 is exhibited.

The heating pad 40 can be manufactured in various sizes so that its use is not subject to any restrictions. Furthermore, by enclosing the entire body of the heating element 10, the heating pad 40 can be formed as a standalone product.

Accordingly, the heating pad 40 is manufactured in a size suitable for the purpose, and thus it can be placed anywhere to be used, such as the seat of a stroller, the seat of a vehicle such as a car, a ship, a train, or an airplane, the seat of a wheelchair, or the seat of a baby carriage.

When the heating pad 40 is manufactured in a relatively large size, it can be used as a cover of a bed, a cover of a sofa, a carpet, a mat, a blanket, a floor member, and can be placed atop or under the bottom of a sleeping bag or a tent. That is, it can be used for all products that require to be heated.

The heating pad 40 can be used in the state of being inserted in one of the above mentioned products besides in the state of being placed atop or under the above-mentioned products. In the case of an item of clothing such as a vest, the vest may have a dedicated pouch and the heating pad can be inserted in the pouch. Alternatively, the heating pad can be sewed to the inside or outside surface of the clothing, or fixed to the clothing using alternative fixing means.

The heating element 10 embedded in the heating pad 40 may be a sheet-type heating element or a flexible heating element. However, the ideal heating element may be a flexible heating element made of a conductive mesh, an elastic heating wire, or a conductive double twisted yarn. The heating element 10 made of any one of the above-mentioned materials has excellent flexibility and elasticity, so that it can be more safely used when it is applied to various objects on which people sit or lie down. That is, the heating element 10 is formed using a flexible heating mesh which is formed by sequentially laminating a conductive layer and an insulating layer on the surface of a core member of a lattice structure, an elastic heating wire formed by sequentially forming a coil-shaped wire and an insulating layer on the surface of an elastic wire, a woven fabric formed by using, as the weft threads and the warp threads, a conductive double twisted thread formed by sequentially forming a conductive layer and an insulating layer on the surface of a core thread which is formed by doubling and twisting glass fiber. Various kinds of heating elements 10 have been used in various fields, the detailed structure and effect thereof are not presented here.

However, when a large-sized heating pad 40 is manufactured using the heating element 10, there is a problem because the power supply is not sufficient and stable and the heating element 10 may not generate heat uniformly. In order to solve the problem, main power lines 11 and 11′ are arranged at both ends of the heating element 10, and auxiliary power lines 12 and 12′ are arranged between the main power lines 11 and 11′ in which all of the power lines are equally spaced apart, so that the voltage and temperature of the heating element 10 can be evenly distributed over the entire area of the heating element 10 due to the main power lines 11 and 11′ and the auxiliary power lines 12 and 12′ equally spaced apart.

The power line includes the main power lines 11 and 11′ arranged at both ends of the heating element 10 and the auxiliary power lines 12 and 12′ arranged between the main power lines 11 and 11′ at an equal interval. The main power lines 11 and 11′ and the auxiliary power lines 12 and 12′ are electrically connected to a conductive portion of the heating element 10. Accordingly, when power is supplied through the main power lines 11 and 11′ and the auxiliary power lines 12 and 12′, the heating element 10 enters a conduction state and at the same time the heating element 10 acts as a resistor so that resistance heat is generated.

Especially of note is that the number of auxiliary power lines 12 and 12′ may vary depending on the width or the length of the heating element 10. When the heating element 10 is very wide or long, the number of the auxiliary power lines 12 and 12′ correspondingly increases so that the distance between the power lines is not excessively long.

Since the heating element 10 can be manufactured while adjusting the number of auxiliary power lines 12 and 12′, even though the heating element 10 is very long, the resistance of the power line is uniform over the entire area of the heating element 10. Accordingly, the voltage drop rarely occurs in the heating element 10, and the current is uniformly distributed over the entire area of the heating element 10. This prevents locally heated portions or locally cold portions from forming.

Moreover the main power lines 11 and 11′ and the auxiliary power lines 12 and 12′ are alternately connected to different polarities. Accordingly, when DC power is used and neighboring power lines have the same polarity, there is no electrical conduction between the power lines. But, this is not the case for an AC power. Accordingly, one main power lines 11 (or 11′, or vice versa) and the auxiliary power lines 12 and 12′ in alternating rows are connected to a positive electrode (or a negative electrode), the others are connected to the negative electrode (or the positive electrode). Accordingly, the heating element 10 can stably and uniformly generate heat. When a heating element operating on a predetermined voltage is designed, the size of a grid of the heating element is adjusted according to the desired voltage, and the interval of the auxiliary power lines 12 and 12′ is also adjusted according to the size of the grid.

The cover member 30 that covers the heating element 10 or is formed on the outer surface of the heating element 10 has an additional effect on the heating pad of the invention, and the effect is improved depending on the material of the cover member 30. The waterproof cover member 30 improves the waterproof characteristic of the heating pad 10, and the cover member 30 made of elastic fiber improves the elasticity of the heating pad 40. The material of the cover member 40 is not particularly limited, and any material may be used as long as it does not deform when heated.

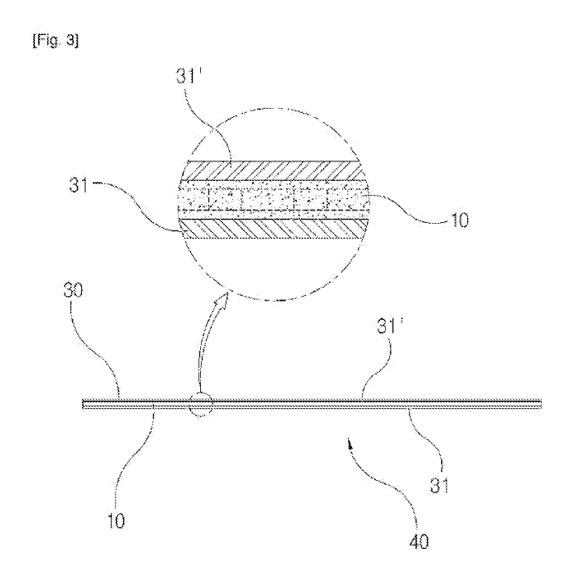

In a case where Neoprene sheets 31 and 31′ are provided as an upper layer and a lower layer, and the heating element 10 is inserted between the Neoprene sheets 31 and 31′, the heating element 10 is first placed on the lower layer of the Neoprene sheet 30 and then the upper layer of the Neoprene sheet 31′ is placed on the heating element 10, as shown in FIG. 3. After that, the stack of the Neoprene sheets 31 and 31′ and the heating element 10 are put under pressure by a hot press. At this time, contact portions of the Neoprene are melted so that the Neoprene sheets 31 and 31′ are physically bonded to each other and the heating element 10 is hidden and integrated with the Neoprene sheets 31 and 31′. This completes the heating pad 40. When Spandex having high elasticity is used to form the cover member 30 instead of Neoprene sheets 31 and 31′, the heating pad 40 has relatively high elasticity compared to the case where Neoprene is used. In such a case, even though various pressures and loads are applied to the heating pad 40 by the movement of a human body thereon, the heating pad 40 can be safely used for a long period of time.

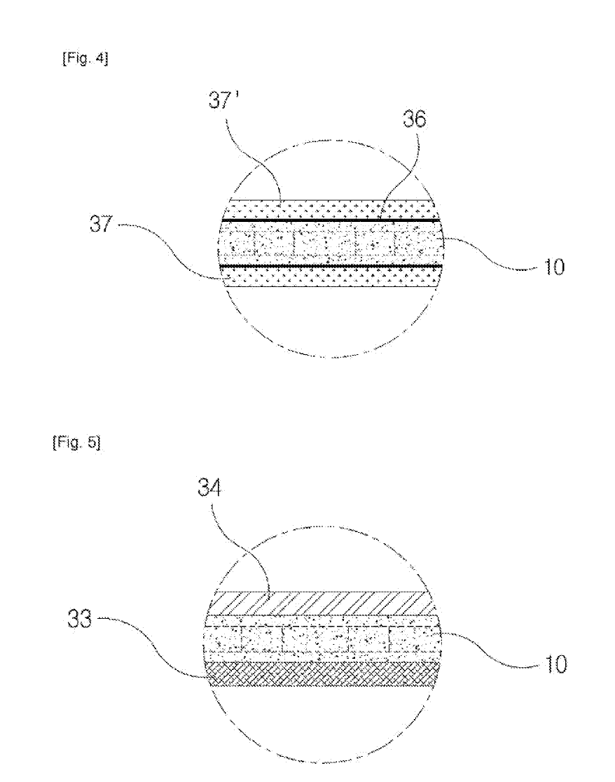

FIG. 4 illustrates an example in which the cover member 30 of the heating pad 40 is formed of polyurethane sheets 37 and 37′. In this case, the heating sheet 40 is manufactured such that adhesive layers 36 made of non-toxic water-soluble adhesive are applied to the surfaces of the heating element 10, the polyurethane sheets 37 and 37′ are glued and fixed to the adhesion layers 36 so as to serve as an upper layer and a lower layer, respectively. Or, after applying the adhesion layers, the heating element 10 is wrapped by one polyurethane sheet. This imparts the heating pad 40 with high elasticity and makes it waterproof, which are characteristics of the polyurethane sheets 37 and 37′.

FIG. 5 illustrates an example in which the cover member 30 of the heating pad 40 is formed using a heat-insulating sheet 33 and a heat storage and transfer sheet 34. The heat-insulating sheet 33 serves to block the propagation of heat from the heating element 10 in one direction, and the heat storage and transfer sheet 34 serves to absorb the heat from the heating element 10 and to allow the heat to be emitted from the surface of the heating element 10.

The heat storage and transfer sheet 34 is formed by superimposing cotton fabric on a Techno Thermo fabric. The Techno Thermo fabric is a novel material manufactured a W-section yarn and a yarn with a light energy absorption function and a heat emitting function and has an improved heat keeping characteristic. Even in cloudy weather when there is the least amount of light energy, it exhibits higher heat-retention than other fabrics. It is made of a material with low heat conduction compared to conventional heat-retaining yarn, so that it allows less heat to leak through the fabric. Accordingly, the heat storage and transfer sheet 34 prevents the heat of the heating element 10 from leaking, minimizing the heat loss. Furthermore, since the cotton fabric imparts softness to the heating pad, the user may be more comfortable when using the heating pad.

Furthermore, the heat-insulating sheet 33 is fabricated using a fiber glass silica pad, which is considered a material suitable for a space suit and which tolerates temperatures of several thousands of degrees centigrade (° C.). Moreover, it completely prevents heat conduction in one direction. Accordingly, the heat-insulating sheet 33 prevents the heat of the heating element 10 from propagating in an undesired direction, and allows the heat to propagate only in the direction toward the human body. This prevents the heat from unnecessarily leaking which improves the efficiency of heating. In the heating pad having the above mentioned structure, the heat from the heating pad 10 disposed between the heat storage and transfer sheet 34 and the heat-insulating sheet 33 can be effectively and uniformly diffused and transferred.

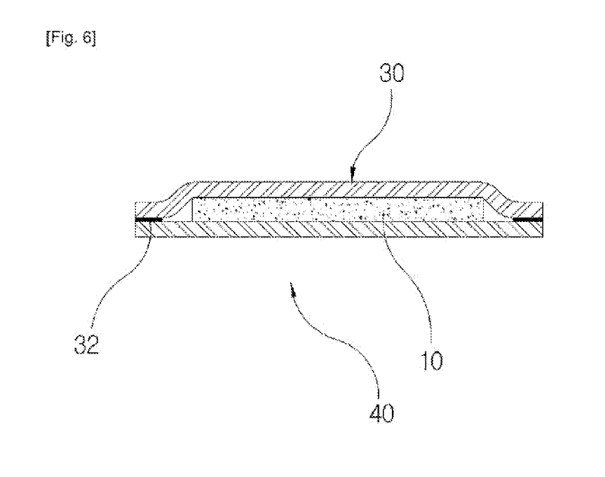

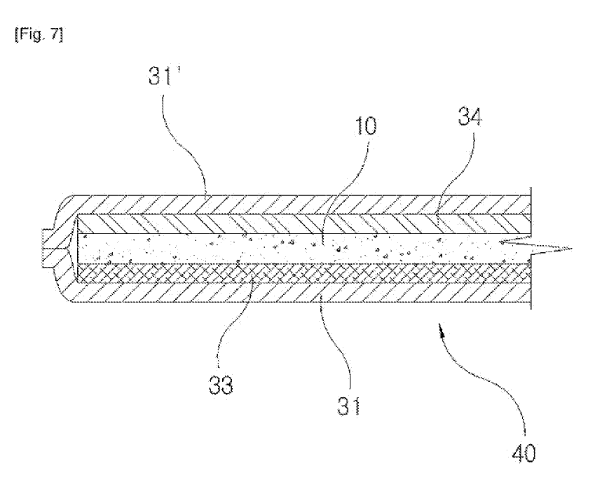

FIG. 6 illustrates an example of enhancing the bonding force between the layers of the cover member 30 when the layers of the cover member 30 are superimposed and bonded to each other. When the upper and lower Neoprene sheets 31 and 31′ or the heat-insulating sheet 33, and the heat storage and transfer sheet are bonded and fixed, an additional adhesion film 32 is interposed between the sheets to provide effective bonding and then the stack of the sheets is put under pressure so as to melt, so that the sheets are strongly bonded.

That is, when the adhesion film 32 such as a vinyl sheet is interposed between the sheets of the cover member 30 and the sheets constituting the cover member 30 are heated and pressed at the same time, since the adhesion film 32 made of vinyl has a very low melting point, various materials having a melting point higher than that of the vinyl can be used for the cover member 30. For example, when the cover member 30 is made of felt (unwoven fabric) or woven fabric, the cover member 30 may have improved durability while exhibiting softness imparted by the felt or the woven fabric.

FIG. 7 illustrates an example in which the cover member 30 used on the heating pad 40 is formed with the Neoprene sheets 31 and 31′, the heat-insulating sheet 33, and the heat storage and transfer sheet 34. The heat storage and transfer sheet 34 and the heat-insulating sheet 33 are in tight contact with the upper and lower surfaces of the heating element 10, and the Neoprene sheets 31 and 31′ or the polyurethane sheets 37 and 37 may be superimposed on the outer surfaces of the heat storage and transfer sheet 34 and the heat-insulating sheet 33 if necessary. After that, the stack of films and the heating element 10 are simultaneously heated and pressed to be integrated with each other, so that the heating pad 40 is completed.

The heating pad 40 having the structure described above has latent heat due to the heat retaining action, and the use of the heat-insulating sheet 33 prevents heat loss. Moreover, the heating pad 40 has improved elasticity, durability, chemical resistance, heat insulation, and waterproof characteristics due to the Neoprene sheets 31 and 31′.

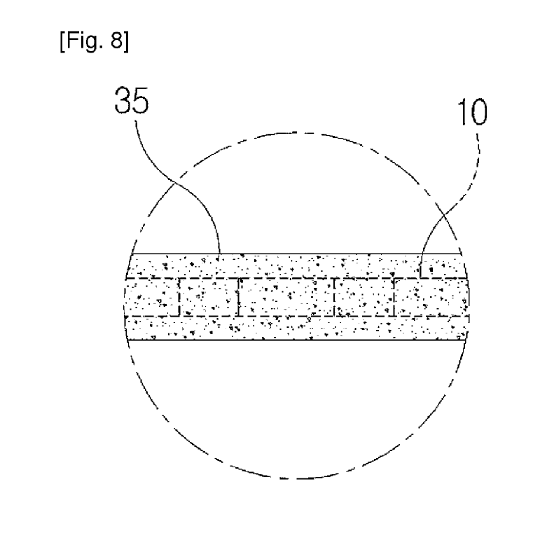

FIG. 8 illustrates an example in which the cover member 30 is formed with urethane foam 35 wherein the urethane foam 35 covers the entire surface of the heating element 10. The polyurethane foam 35 formed on the upper and lower surfaces and in gaps between the heating elements 10 arranged in a mesh form or a grid form fills all gaps or spaces in the heating element 10 and the cover member 30, so that the heating pad 40 has even better waterproof and sealing characteristics. Furthermore, the polyurethane foam 35 having excellent flexibility and elasticity is an ideal material for imparting flexibility and elasticity to the heating pad 40. Besides, since the polyurethane foam 35 has good heat insulation, it is a reasonable material for imparting the heating pad 40 with heat insulation.

In the heating pad 40 in which the heating element 10 is enclosed by any one of various types of cover members 30 made of various materials described, one heating element 10 may be inserted in the cover member 30. However, it is more preferable for the heating element 10 to be divided into a plurality of sections having the same or different sizes, and each of the sections of the heating element 10 may be enclosed by the cover member 30. This method is more preferable in terms of saving power.

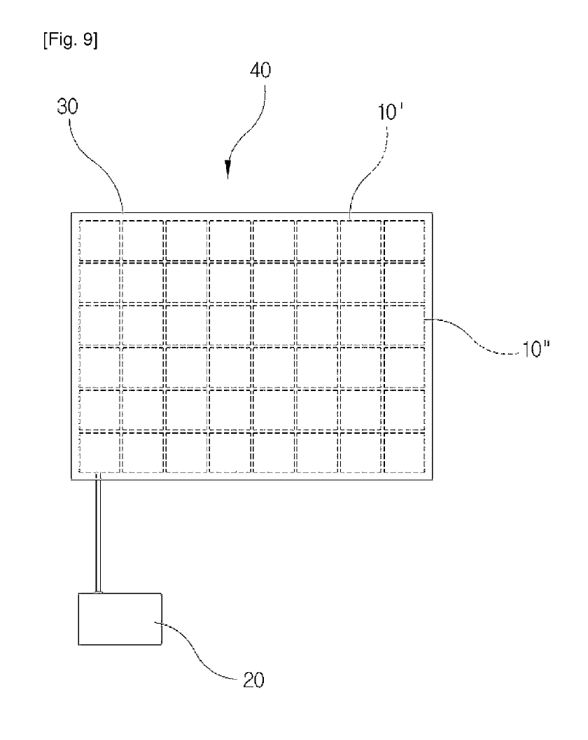

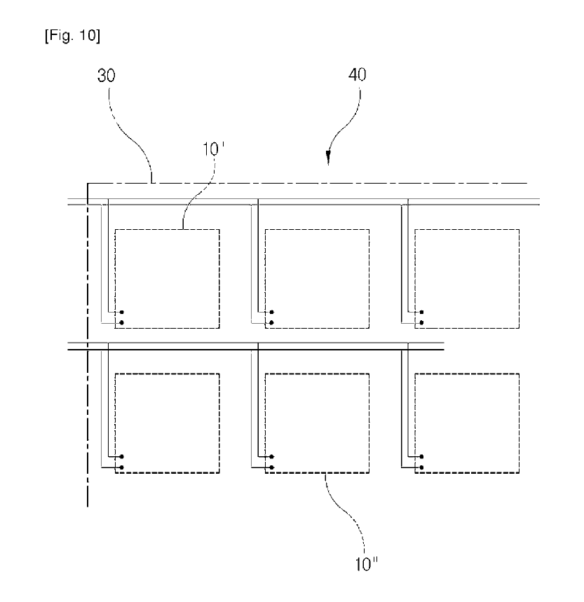

That is, as illustrated in FIG. 9, the heating member 10 to be inserted in the cover member 30 is divided vertically and horizontally into a plurality of sections, and all of the heating element sections 10′ and 10″ may be connected in parallel with a controller 20, or may be separately and independently connected to the controller 20 via their own power lines.

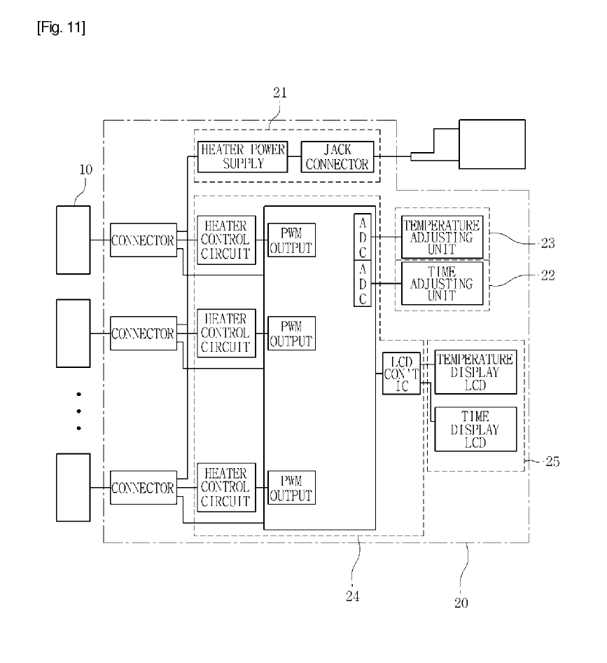

When all of the heating element sections 10′ and 10″ are connected in parallel with the controller 20, the supply of power to all of the heating element sections 10′ and 10″ simultaneously starts and stops. Accordingly, the heating pad 40 can have an even temperature over its entire area. On the other hand, when the heating element sections 10′ and 10″ are individually connected to the controller 20, as shown in FIG. 10, the power supply to the heating element sections 10′ and 10″ can be carried out simultaneously or individually, and can be stopped simultaneously or individually. When the power supply to the heating element sections 10′ and 10″ can be individually allowed or stopped, the heating element sections 10′ and 10″ can be controlled to sequentially generate heat. In the case where the heating element sections 10′ and 10″ are controlled to sequentially generate heat or sequentially stop heat generation, it is possible to reduce the power by 70% in comparison with the case where all of the heating element sections 10′ and 10″ are operated simultaneously.

That is, the following sequence control may be possible: all of the heating element sections 10′ and 10″ simultaneously generate heat at an early stage of the operation, power supply to all of the heating element sections 10′ and 10″ is simultaneously stopped when the temperature of the heating pad has reached a predetermined temperature, and power is sequentially supplied to a single heating element section 10′ or 10″ or a group of the heating element sections 10′ and 10″.

When the heat generation is sequentially performed by the heating element sections, power consumption is remarkably reduced compared to the case where all the heating element sections simultaneously generate heat. Furthermore, a certain extent of the heat generated from the heating element sections 10′ and 10″ is stored in the heating pad 40 and gradually emitted with time due to the characteristics of the cover member 30, the power saving effect is large.

The controller 20, which supplies power to the heating element 10 which is formed as a single body or as a plurality of sections, includes a power supply unit 21 with a jack connector which is connectable to an AC or DC power supply as illustrated in FIG. 11. A central processing unit 24 connected to the power supply unit 21 is also connected to each of a time adjusting unit 22 and a temperature adjusting unit 23. The heating temperature and time of the heating element 10 can be freely adjusted by the time adjusting unit 22 and the temperature adjusting unit 23. The heating time and temperature which are set, or the state of charge, can be confirmed via a display unit 25.

The power supply unit 21 can be connected to a general household AC power supply, or a DC power supply using an additional adapter or a rechargeable battery. When the DC power supply is used, a super-capacitor is used in combination with the DC power supply. Alternatively, when the rechargeable battery can be built in the controller 20, an additional AC adapter is used to charge the rechargeable battery or to directly supply power to the controller. Moreover, when the rechargeable battery is built in the power supply unit 21, the heating pad 40 can generate heat using the power charged in the rechargeable battery. In such a case, the heating pad 40 can be carried and used outdoors, or can be used at places in a house where it is difficult to be connected to a household power supply. So, it is convenient to use at locations where it is difficult to get power.

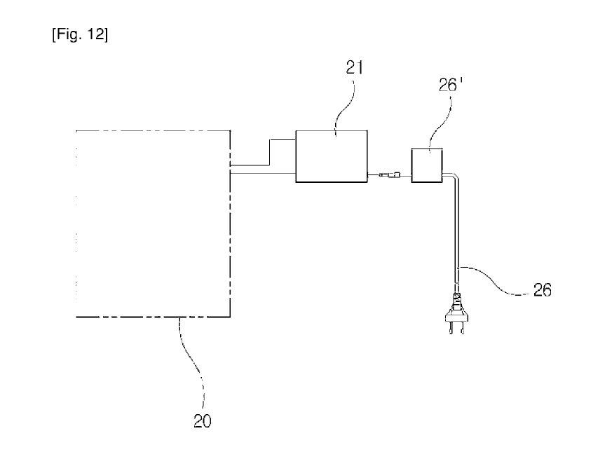

The power supply unit 21 combined with the controller 20 allows the heating element 10 of the heating pad 40 to be powered from the AC power supply, the DC power supply, or the rechargeable battery according to the user's choice. In order to directly use the household power supply, as illustrated in FIG. 12, an AC cord 26 to be connected to the power supply unit 21 of the controller 20, and a voltage-down transformer 26′ have to be prepared. That is, a general household power supply having a voltage of AC 220 V is connected to the voltage-down transformer 26′ through the AC cord 26, and then a low voltage of, for example, AC 24 V is supplied to the power supply unit 21. The power supply unit 21 supplied with the low voltage supplies the power to the heating element 10 under the control of the controller 20.

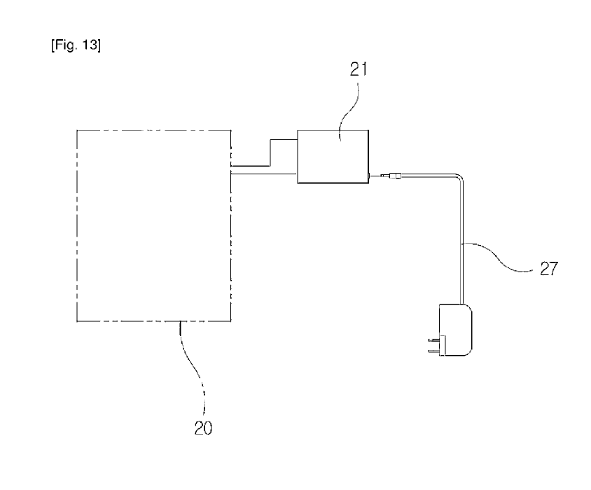

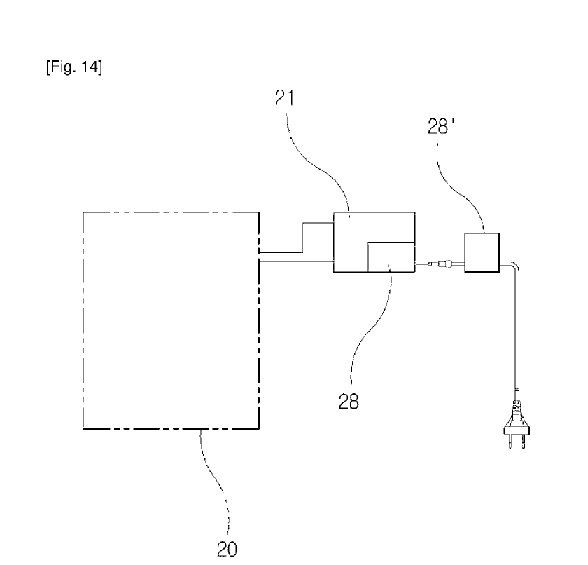

Alternatively, instead of using the AC cord 26 and the voltage-down transformer 26′, an AC adapter 27 in which a transformer circuit and a rectifier circuit are included may be used, as shown in FIG. 13. In this case, AC power of the household power supply, which has a high voltage, is converted into DC power of a low voltage of 24V by the AC adapter 27, and then the converted voltage is supplied to the power supply unit 21. In the case where a chargeable unit 28 is included in the power supply unit 21 and a charging unit 28′ to be connected to the chargeable unit 28 is prepared as illustrated in FIG. 14, the chargeable unit 28 is charged using the charging unit 28′. In this case, the controller 20 and the heating pad 40 can be used as a portable heating pad. Accordingly, it can be effectively applied to various products which need to be carried or used outdoors, for example, a stroller, a wheelchair, a tent, and a sleeping bag.

The embodiments described in the specification and the structures illustrated in the drawings have been disclosed for illustrative purpose, and therefore do not represent all of the technical spirits of the invention. Accordingly, those skilled in the art will appreciate that various equivalents and various modifications are possible.

1. A multipurpose heating pad (40) including a heating element (10) connected to a controller (20), wherein
the heating element (10) generates heat according to control of a supply of power performed by the controller (20),
a cover member (30) is provided to enclose an entire body of the heating element (10) to protect the heating element (10),
when power is supplied to the controller (20), the heating element (10) operates according to a temperature and a time set by the controller (20),
the heat from the heating element (10) is transferred to the surface of the heating pad (40) through the cover member (30),
the heating element (10) includes a plurality of heating element sections (10′)(10″) arranged in a vertical direction and a horizontal direction and spaced from each other,
the heating element sections (10′)(10″) are individually and sequentially supplied with power or power supply to the heating element sections (10′)(10″) is individually and sequentially stopped, and
each of the heating element sections (10′)(10″) is sequentially repeatedly operated with a predetermined heat generation cycle.

2. The multipurpose heating pad according to claim 1, wherein the controller 20 includes:
a power supply unit (21) that receives power from outside;
a time adjusting unit (22) that adjusts the heating time;
a temperature adjusting unit (23) that adjusts the heating temperature,
a central processing unit (24) that automatically controls supply from the power supply unit (21) to the heating element (10) according to the time and the temperature set by the time adjusting unit (22) and the temperature adjusting unit (23); and
a display unit (25) that displays the set heating temperature, the heating temperature and the set heating time.

3. The multipurpose heating pad according to claim 2, wherein the power supply unit (21) is structured to receive a voltage of AC 24 V or lower which is transformed from power of a household power supply by an AC cord (26) and a voltage down transformer (26′).

4. The multipurpose heating pad according to claim 2, wherein the power supply unit 21 is configured to receive a voltage of DC 24 V or lower which is converted from power of a household power supply by an AC adapter (27) including a transformer circuit and a rectifier circuit therein.

5. The multipurpose heating pad according to claim 2, wherein the power supply unit (21) includes a chargeable unit (28), wherein
the chargeable unit (28) is connected to a charging unit (28′) including a transformer circuit, a rectifier circuit, and a charging circuit, and
the power supply unit (21) enables the heating element (10) to be supplied with power while the heating element (10) is being carried after the chargeable unit 28 has been completely charged.
